(19) United States
(12) Patent Application Publication
(10) Pub. No.: US 2008/0002769 A1
(43) Pub. Date: Jan. 3, 2008

(54) MOTION PICTURE CODING APPARATUS AND METHOD OF CODING MOTION PICTURES

(75) Inventor: Hajime MATSUI, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/765,858

(22) Filed: Jun. 20, 2007

(30) Foreign Application Priority Data
Jun. 30, 2006 (JP) 2006-182776

(51) Int. Cl. H04N 7/26; H04N 11/02

(52) U.S. Cl. 375/240.13; 375/E07.243; 375/E07.104

(57) ABSTRACT

A coding method which demonstrates the best coding efficiency when using inter-frame prediction is determined (S1) to calculate the coding efficiency evaluation value InterCost (S2). Then, a coding method which demonstrates the best color difference signal coding efficiency when using intra-frame prediction is determined (S3) to calculate the coding efficiency evaluation value IntraChromaCost (S4). At this time, InterCost and IntraChromaCost are compared (S5), and when the relation InterCost<IntraChromaCost is satisfied, it is determined to use the inter-frame prediction and the process is ended. Otherwise, a luminance signal coding method which demonstrates the best coding efficiency when the intra-frame prediction is used is determined (S6) to calculate the coding efficiency evaluation value IntraLumaCost (S7). IntraCost is calculated by adding IntraLumaCost and IntraChromaCost (S8), and InterCost and IntraCost are compared (S9). If the relation InterCost<IntraCost is satisfied, it is determined to use the inter-frame prediction, and otherwise, it is determined to use the intra-frame prediction.

### CROSS-REFERENCE TO RELATED APPLICATIONS

This application is based upon and claims the benefit of priority from the prior Japanese Patent Application No. 2006-182776, filed on Jun. 30, 2006; the entire contents of which are incorporated herein by reference

### TECHNICAL FIELD

The present invention relates to a motion picture coding apparatus for coding video signals using intra-frame prediction and inter-frame prediction and a method of coding motion pictures.

### BACKGROUND OF THE INVENTION

In many motion picture coding systems, efficient coding is achieved by generating prediction signals using temporal correlation or spatial correlation of the motion picture and coding predicted residual signals and information required for generating the prediction signals.

In MPEG-1 and MPEG-2, an inter-frame prediction coding in which prediction signals are generated by performing motion compensation from a pixel value of a coded frame on the basis of the temporal correlation between the motion pictures is employed. However, when the accuracy of motion compensation is not very high as in the case of a scene change, an intra-frame coding in which the pixel value is directly coded is employed.

Through the usage of the intra-frame prediction coding in which the prediction signals are generated from adjacent pixel values in the frame on the basis of the spatial correlation of the images in addition to the inter-frame prediction coding, the coding efficiency is further improved.

For example, in H.264, a plurality of prediction modes are provided for luminance signals and color difference signals respectively for generating the prediction signals through the intra-frame prediction coding.

In Japanese Application Kokai No. 2003-230149 incorporated herein by reference, the coding efficiency is improved by selecting one of the inter-frame prediction coding and the intra-frame prediction coding to be used on the basis of calculation of the cost from distortion generated by coding and the amount of coding.

In Japanese Application Kokai No. 2005-244749 incorporated herein by reference, reduction of the throughput is achieved by determining which one of the inter-frame prediction coding and the intra-frame prediction coding is used before generating intra-frame prediction signals.

With a method disclosed in Japanese Application Kokai No. 2003-230149, a high coding efficiency is achieved. However, there is a problem that the throughput is astronomically increased. In particular, in H.264 for example, since a number of prediction modes are proposed for the intra-frame prediction coding, a large throughput is required for generating, for example, the intra-frame prediction signals or selecting a suitable intra-frame prediction system.

Through the usage of the methods disclosed in Japanese Application Kokai No. 2005-244749, reduction of the throughput is achieved. However, there is a case in which the coding efficiency is lowered due to the wrong selection.

### BRIEF SUMMARY OF THE INVENTION

Accordingly, it is an object of the invention is to provide a motion picture coding apparatus in which the throughput required for determining the coding system is reduced without lowering the coding efficiency and a method of coding motion pictures.

According to embodiments of the invention, there is provided a motion picture coding apparatus for coding input signals of motion pictures using inter-frame prediction and intra-frame prediction including: a first evaluation value estimating unit configured to estimate a first evaluation value which indicates a coding efficiency based on an inter-frame prediction signal; a second evaluation value estimating unit configured to estimate a plurality of evaluation values which indicate coding efficiencies based on inter-frame color difference prediction signals generated according to respective inter-frame color difference prediction modes; an intra-frame color difference prediction mode selecting unit configured to select a best intra-frame color difference prediction mode having a best second evaluation value based on the second evaluation value; a first comparing unit configured to compare the first evaluation value and the best second evaluation value and determine a better one in a coding efficiency from the first evaluation value and the best second evaluation value; a first selecting unit configured to select the inter-frame prediction when the first comparing unit determines the first evaluation value is the better one; a third evaluation value estimating unit configured to estimate a plurality of third evaluation values which indicate coding efficiencies of intra-frame luminance prediction modes based on intra-frame luminance prediction signals generated according to the respective luminance prediction modes when the first comparing unit determines that the best second evaluation value is the better one; an intra-frame luminance prediction mode selecting unit configured to select a best intra-frame luminance prediction mode having a best third evaluation based on the third evaluation values; a second comparing unit configured to compare the sum of the best second evaluation value and the best third evaluation value with the first evaluation value and determine a better one in a coding efficiency from the sum and the first estimation value; a second selecting unit configured to select the inter-frame prediction when the second comparing unit determines that the first evaluation value is the better one; a third selecting unit configured to select the intra-frame prediction including the best intra-frame color difference prediction mode and the best intra-frame luminance prediction mode when the second comparing unit determines that the sum is the best one; and a coding unit configured to perform prediction coding through a prediction system selected by any one of the first selecting unit, the second selecting unit, and the third selecting unit. According to the invention, the number of time of the intra-frame prediction coding process for the luminance signals may be reduced and the throughput required for determining the coding system may be reduced without lowering the coding efficiency.

### BRIEF DESCRIPTION OF THE DRAWINGS

FIG. 1 is a flowchart of a prediction mode determination process according to a first embodiment of the invention;

FIG. 2 is a flowchart of an inter prediction mode determination process according to the first embodiment;

FIG. 3 is a flowchart of an IntraChroma prediction mode determination process according to the first embodiment;

FIG. 4 is a flowchart of an IntraLuma prediction mode determination process according to the first embodiment;

FIG. 5 is a flowchart of an Intra4×4 prediction mode determination process according to the first embodiment;

FIG. 6 is a flowchart of an Intra8×8 prediction mode determination process according to the first embodiment;

FIG. 7 is a flowchart of an Intra16×16 prediction mode determination process according to the first embodiment;

FIG. 8 is a flowchart of an Intra4×4 prediction mode determination process according to a second embodiment of the invention;

FIG. 9 is a block diagram showing a configuration of a motion picture coding apparatus according to the first embodiment;

FIG. 10 is a block diagram showing a modification of the configuration of the motion picture coding apparatus according to the first embodiment;

FIG. 11 is a correlation chart between the generated code amount predicted value R_{PRED} and the generated code amount R, and

FIG. 12 is a correlation chart between the coding distortion approximate value Dₐₚₚᵣₒₓ and the coding distortion D.

### DETAILED DESCRIPTION OF THE PREFERRED EMBODIMENTS

Referring now to the drawings, a motion picture coding apparatus according to embodiments of the invention will be described.

### First Embodiment

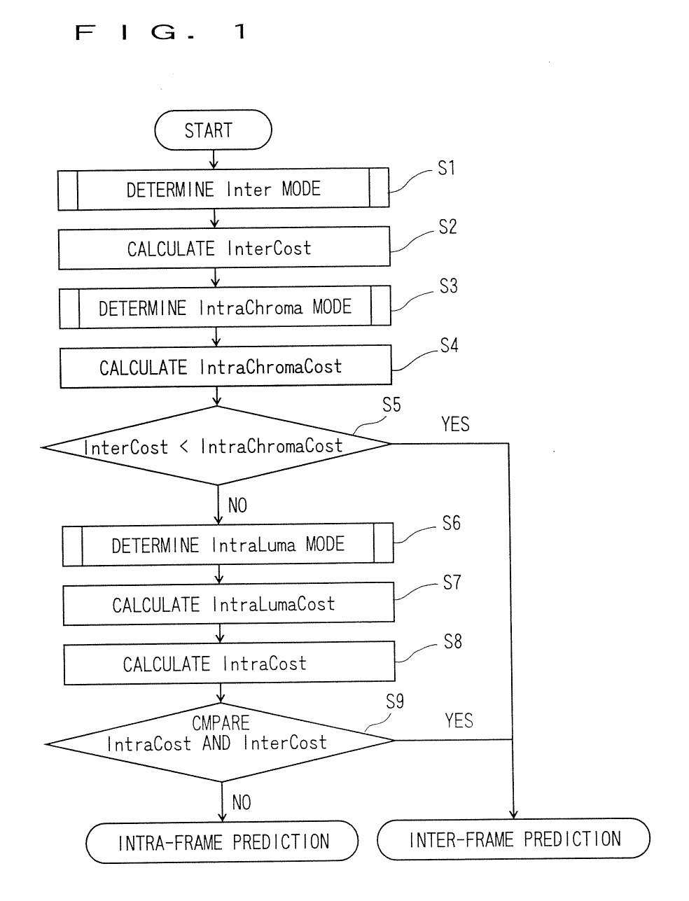

Referring now to FIGS. 1 to 7 and FIG. 9, a motion picture coding apparatus according to a first embodiment will be described.

### (1) Configuration of Motion Picture Coding Apparatus

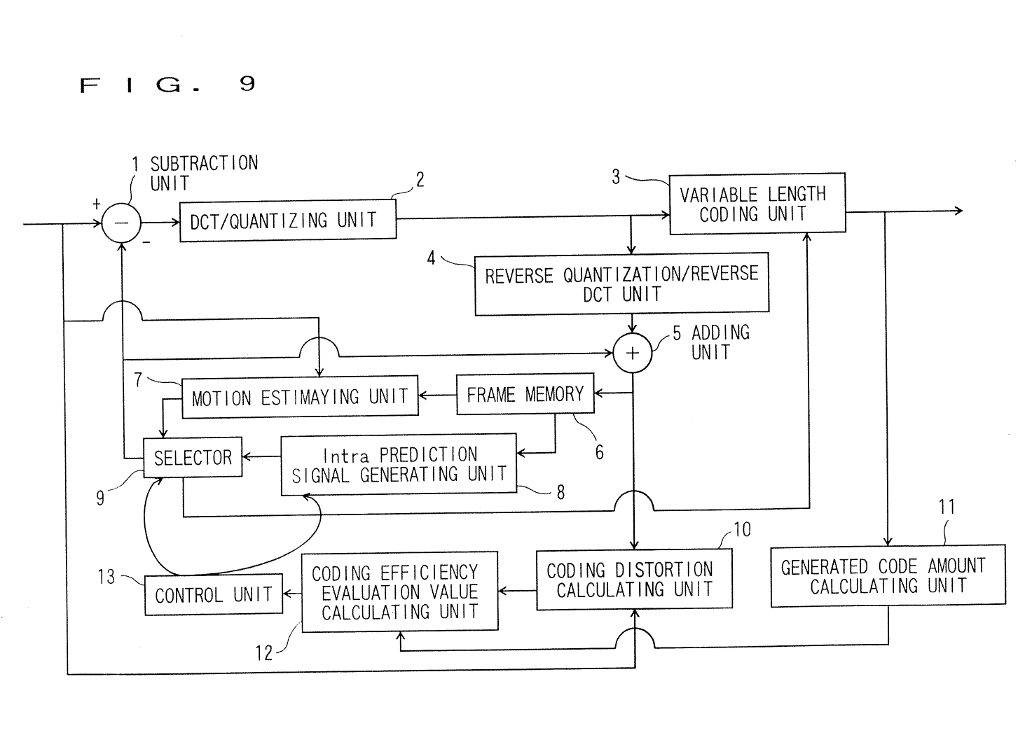

FIG. 9 is a block diagram showing an example of a configuration of the motion picture coding apparatus according to the embodiment.

A subtraction unit 1 subtracts a prediction signal outputted from a selector 9 from an input signal and outputs a prediction residual signal.

DCT/quantizing unit 2 applies DCT to the prediction residual signal outputted from the subtraction unit 1 and quantizes the transform coefficients, and outputs the obtained value.

A variable length coding unit 3 applies variable length coding to transform coefficients after quantization outputted from the DCT/quantizing unit 2, and information, such as prediction mode or motion vectors, outputted from the selector 9 to output a coding signal.

A reverse quantization/reverse DCT unit 4 quantizes the transform coefficients after quantization outputted from the DCT/quantizing unit 2 reversely and applies the reverse DCT, and outputs the obtained signal.

An adding unit 5 adds the signal outputted from the reverse quantization/reverse DCT unit 4 to the prediction signal outputted from the selector 9 and outputs a local decode signal.

A frame memory 6 stores the local decode signal outputted from the adding unit 5 as a reference frame to be used for the inter-frame prediction.

A motion estimating unit 7 determines an inter-frame prediction coding method having a good coding efficiency by performing the motion estimation from reference frames stored in the frame memory 6 and a pixel value of the input signal, and outputs information required for generating prediction signals such as the prediction modes and the motion vectors.

An Intra prediction signal generating unit 8 generates an intra-frame prediction signal from the value of the local decode signal stored in the frame memory 6, and outputs a prediction signal and prediction mode information required for generating the prediction signal.

The selector 9 receives the output from the motion estimating unit 7 and the Intra prediction signal generating unit 8, and when an instruction to perform the inter-frame prediction is issued from a control unit 13, outputs information on the prediction signal outputted from the motion estimating unit 7, the motion vectors, and so on. When an instruction to perform the intra-frame prediction is issued, the selector 9 outputs the prediction signal outputted from the Intra prediction signal generating unit 8 and prediction mode information.

A coding distortion calculating unit 10 calculates a coding distortion from the local decode signal outputted from the adding unit 5 and the input signal and outputs the calculated value.

A generated code amount calculating unit 11 counts the number of bits of the coding signal outputted from the variable length coding unit 3 and outputs the counted value as a generated code amount.

A coding efficiency evaluation value calculating unit 12 calculates a coding efficiency evaluation value from the coding distortion outputted from the coding distortion calculating unit 10 and the generated code amount outputted from the generated code amount calculating unit 11 and outputs the calculated value.

The control unit 13 performs a control as shown below in sequence.

Firstly, the control unit 13 issues an instruction to perform the inter-frame prediction to the selector 9, and determines an evaluation value outputted from the coding efficiency evaluation value calculating unit 12 as InterCost.

Then, the control unit 13 issues an instruction to output only a prediction signal of a color difference signal to the Intra prediction signal generating unit 8 and issues an instruction to perform the intra-frame prediction to the selector 9, and determines an evaluation value outputted from the coding efficiency evaluation value calculating unit 12 as IntraChromaCost. At this time, when the relation IntraChromaCost>InterCost is satisfied, the control unit 13 determines to use the inter-frame prediction coding. Otherwise, the control unit 13 issues an instruction to output only a prediction signal of a luminance signal to the Intra prediction signal generating unit 8 and issues an instruction to perform the intra-frame prediction to the selector 9, and determines an evaluation value outputted from the coding efficiency evaluation value calculating unit 12 as the IntraLumaCost.

In addition, assuming that IntraCost=IntraLumaCost+IntraChromaCost is established, and when the relation IntraCost>InterCost is satisfied, the control unit 13 determines to use the inter-frame prediction coding, and otherwise, to use the intra-frame prediction coding. The processes described above are referred to as “provisional coding”.

The control unit 13 issues an instruction to perform the inter-frame prediction to the selector 9 when having determined to use the inter-frame prediction coding, the control unit 13 issues an instruction to output the luminance signal and the color difference signal together to the Intra prediction signal generating unit 8 when having determined to use the intra-frame prediction coding, and issues an instruction to perform the intra-frame prediction to the selector 9.

Accordingly, the coding method having a high coding efficiency is selected from between the inter-frame prediction coding and the intra-frame prediction coding and the input signal is coded and outputted as the coding signal.

Functions of the respective members 1 to 13 are implemented by a program stored in a computer.

### (2) Coding System

FIG. 1 shows a flowchart of determining the prediction system by the unit of macro block according to the first embodiment when the H.264 (High Profile) is used as the coding system.

Firstly, in an Inter mode determination step, a coding method BestInter which demonstrates the best coding efficiency when using the inter-frame prediction is determined (S1), and the coding efficiency evaluation value InterCost of the coding method BestInter is calculated (S2).

Then, in the IntraChroma mode determination step, a color difference signal coding method BestIntraChroma which demonstrates the best coding efficiency when using the intra-frame prediction is determined (S3), and the coding efficiency evaluation value IntraChromaCost of the coding method BestIntraChroma is calculated (S4).

At this time, InterCost and IntraChromaCost are compared (S5), and when the relation InterCost<IntraChromaCost is satisfied, it is determined to use the inter-frame prediction and the process is ended.

Otherwise, in an IntraLuma mode determination step, a luminance signal coding method BestIntraLuma which demonstrates the best coding efficiency when the intra-frame prediction is used is determined (S6), and the coding efficiency evaluation value IntraLumaCost of the coding method BestIntraLuma is calculated (S7).

IntraCost is calculated by adding IntraLumaCost and IntraChromaCost (S8), and InterCost and IntraCost are compared (S9). If the relation InterCost<IntraCost is satisfied, it is determined to use the inter-frame prediction, and otherwise, it is determined to use the intra-frame prediction.

In Step S5, when the relation InterCost<IntraChromaCost is satisfied, an intra-frame coding process of the luminance signal can be omitted, and the throughput may be reduced.

When the relation InterCost<IntraChromaCost is satisfied by using the coding efficiency evaluation value which takes non-negative values, the relation InterCost<IntraCost is absolutely achieved. Therefore, the coding efficiency is not lowered by omitting the intra-frame coding process of the luminance signal.

An intra-frame prediction coding process of the color difference signal requires less calculating amount than the intra-frame prediction coding process of the luminance signal. Because there are (9¹⁶+4¹⁶+4) luminance prediction signal generating methods, while there are only four color difference prediction signal generating methods. Since the number of pixels of the luminance signal is 16×16 and the number of pixels of the color difference signal is 8×8, the throughput required for generating one prediction signal is smaller for the color difference signal.

### (3) Inter Mode Determination Step

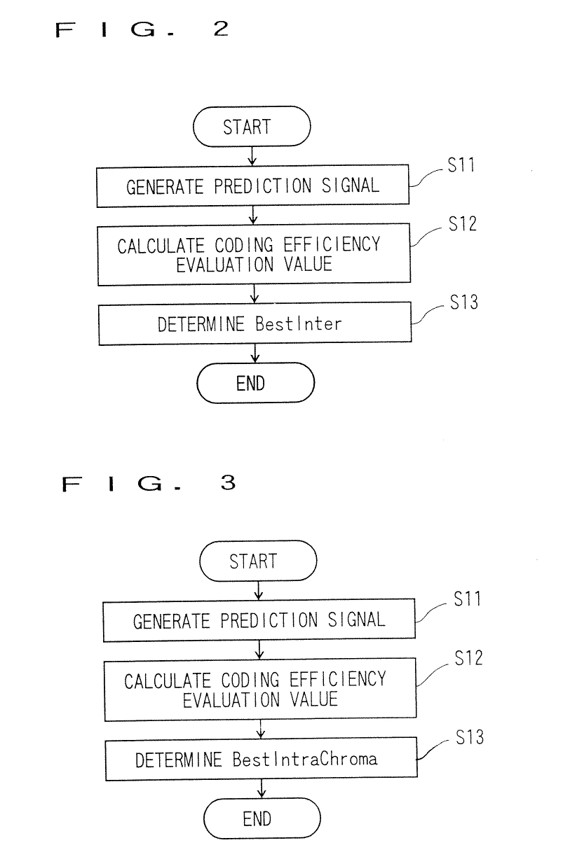

FIG. 2 is a flowchart of BestInter determination in the Inter mode determination step.

The prediction signal in the inter-frame prediction is generated on the basis of the combination of prediction information such as the motion compensation block size, the direction of prediction (L0, L1, BiPred), the motion vectors, and the reference frame indices. The Inter mode determination unit receives a combination of the prediction information from an external motion estimating unit, not shown in the drawing, and generates the prediction signal (S11). Subsequently, the coding efficiency evaluation value is calculated for a case in which the block size when applying the orthogonal transformation to the prediction residual signal is 4×4 and for a case in which it is 8×8 (S12) and, in the combination of the prediction information described above, the inter-frame prediction coding using the block size for the orthogonal transformation whose evaluation value is small is determined as BestInter (S13).

In the Inter mode determination step, a plurality of combinations of the prediction information is received from the external motion estimating unit, and in this case, the coding efficiency evaluation values are calculated by the measure shown above for the respective combinations of the prediction information, and Inter prediction coding using the combination of the prediction information and the block size for the orthogonal transformation whose evaluation values are the smallest is determined as BestInter.

### (4) IntraChroma Mode Determination Step

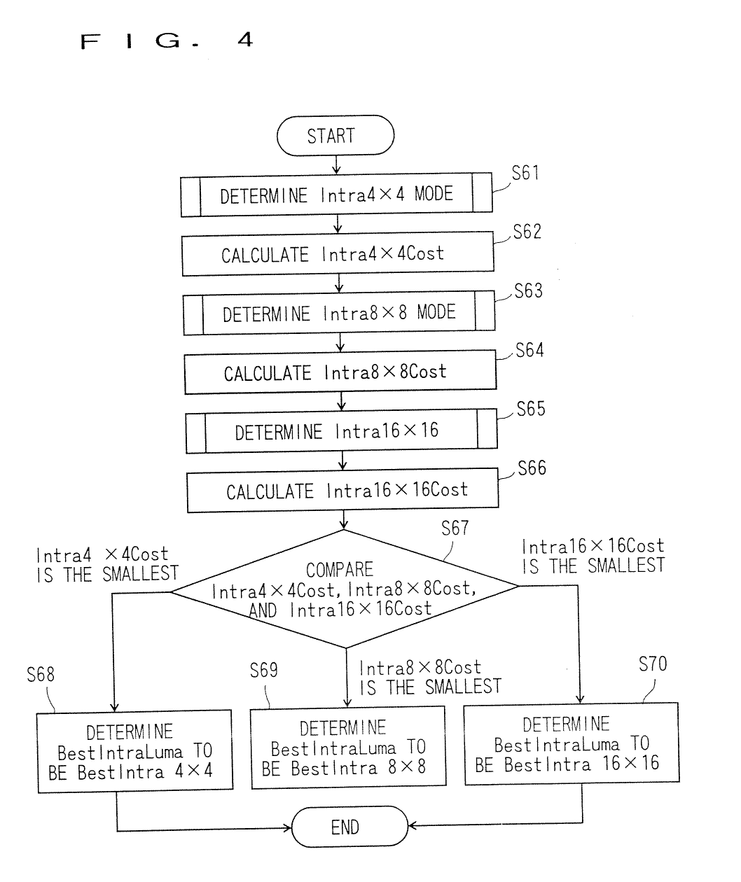

FIG. 3 is a flowchart of BestIntraChroma determination in the IntraChroma mode determination step.

The color difference prediction signal obtained by the intra-frame prediction signal is generated on the basis of the direction of prediction (DC, Horizontal, Vertical, Plane). In IntraChroma mode determination step, firstly, the prediction signal is generated in terms of four directions of predictions (S31).

Then, the coding efficiency evaluation values are calculated respectively (S32), and the intra-frame prediction coding using the direction of prediction in which the evaluation value is the smallest is determined as BestIntraChroma (S33).

### (5) IntraLuma Mode Determination Step

FIG. 4 is a flowchart of BestIntraLuma determination in the IntraLuma mode determination step.

In the IntraLuma mode determination step, firstly, in the Intra4×4 mode determination step, a coding method BesIntra4×4 which demonstrates the best coding efficiency when Intra4×4 prediction is used is determined (S61), and the coding efficiency evaluation value Intra4×4Cost of BestIntra4×4 is calculated (S62).

In Intra8×8 mode determination step, a coding method BestIntra8×8 which demonstrates the best coding efficiency when Intra8×8 prediction is used is determined (S63), and the coding efficiency evaluation value Intra8×8Cost of BestIntra8×8 is calculated (S64).

In Intra16×16 mode determination step, a coding method BestIntra16×16 which demonstrates the best coding efficiency when Intra16×16 prediction is used is determined (S65), and the coding efficiency evaluation value Intra16×16 of BestIntra16×16 is calculated (S66).

At this time, three values of Intra4×4Cost, Intra8×8Cost, Intra16×16Cost are compared (S67), and when the Intra4×4Cost is the smallest, the BestIntra4×4 is determined as BestIntraLuma (S68). When Intra8×8Cost is the smallest, the BestIntra8×8 is determined as BestIntraLuma (S69). When Intra16×16Cost is the smallest, BestIntra16×16 is determined as BestIntraLuma (S70).

### (6) Intra4×4 Mode Determination Step

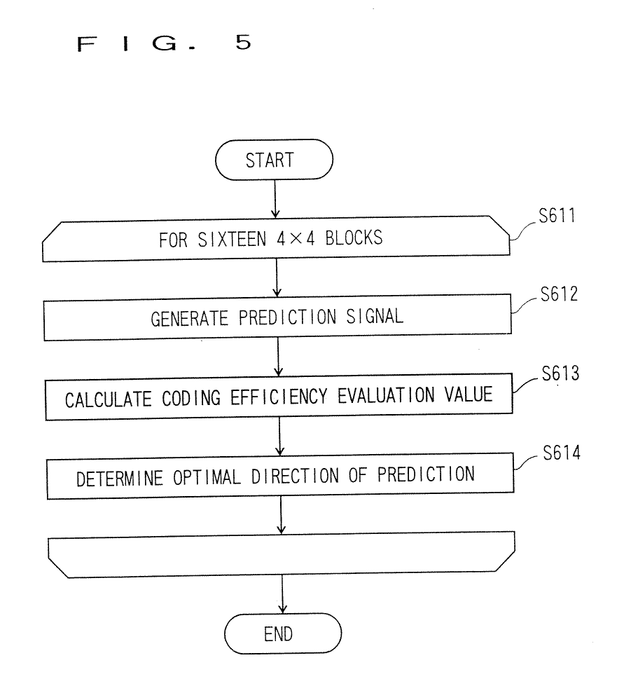

FIG. 5 is a flowchart of BestIntra4×4 determination in the Intra4×4 mode determination step.

The prediction signal obtained by Intra4×4 prediction is generated on the basis of the direction of prediction specified by each of sixteen 4×4 blocks (Vertical, Horizontal, DC and so on). In Intra4×4 mode determination step, the prediction signals in a case in which the respective directions of prediction are used are generated (S612) for each 4×4 block (S611), the coding efficiency evaluation values are calculated (S613), and the direction of prediction whose evaluation value is the smallest is determined as the optimal direction of prediction of a target block (S614). The process described above is applied to the sixteen blocks, and the Intra4×4 prediction coding using the obtained sixteen optimal directions is determined as BestIntra4×4.

### (7) Intra8×8 Mode Determination Step

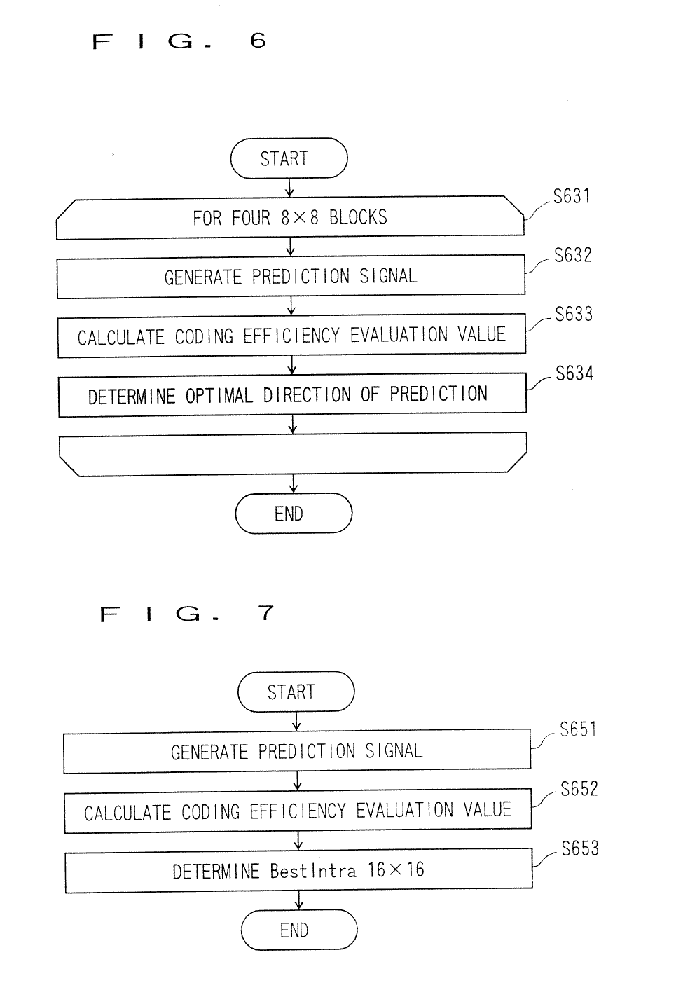

FIG. 6 is a flowchart of BestIntra8×8 determination in the Intra8×8 mode determination step.

The prediction signal obtained by Intra8×8 prediction is generated on the basis of the directions of prediction specified by each of four 8×8 blocks (Vertical, Horizontal, DC and so on). In Intra8×8 mode determination step, the prediction signals in a case in which the respective directions of prediction are used are generated (S632) for each 8×8 block (S631), the coding efficiency evaluation value is calculated (S633), and the direction of prediction whose evaluation value is the smallest is determined as the optimal direction of prediction of the target block (S634). The process described above is applied to the four blocks, and Intra8×8 prediction coding using the obtained four optimal directions is determined as BestIntra8×8.

### (8) Intra16×16 Mode Determination Step

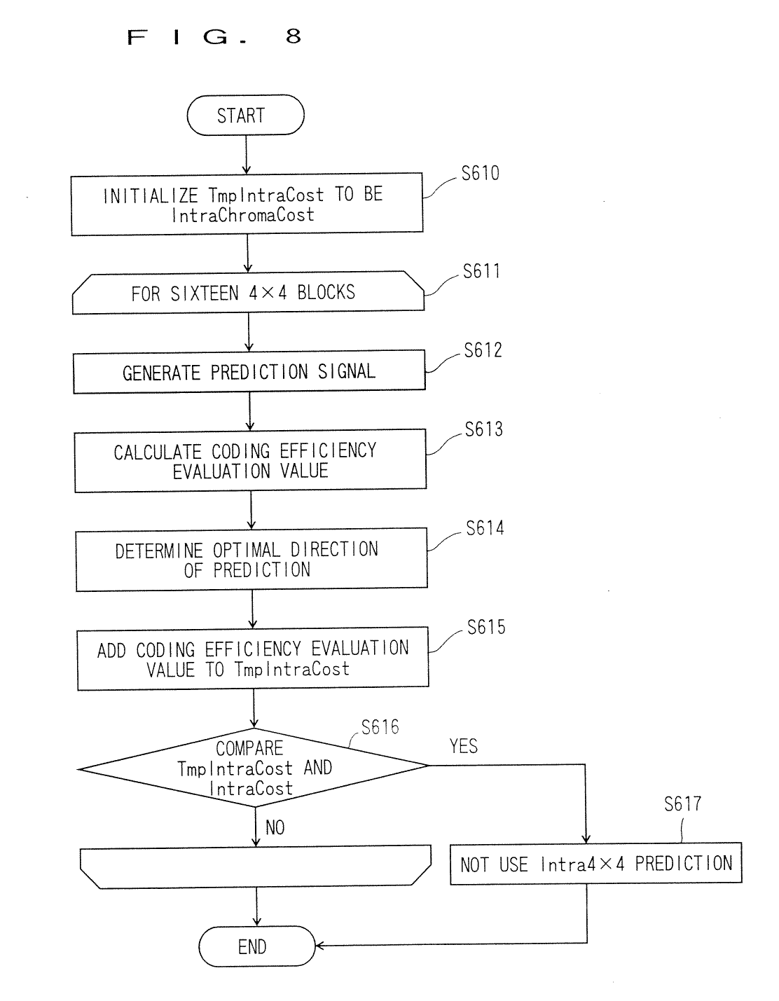

FIG. 7 is a flowchart of BestIntra16×16 determination in the Intra16×16 mode determination step.

The prediction signal obtained by Intra16×16 prediction is determined by the directions of prediction (Vertical, Horizontal, DC, Plane). In Intra16×16 mode determination step, the prediction signals are firstly generated for four directions of prediction (S651). Subsequently, the respective coding efficiency evaluation values are calculated (S652), and Intra16×16 prediction coding using the direction of prediction whose evaluation value is the smallest is determined as BestIntra16×16 (S653).

### (9) First Method of Determining Coding Efficiency Evaluation Value

In calculation of InterCost, IntraLumaCost, IntraChromaCost and respective mode determination steps, an evaluation value J=D+λ·R using the coding distortion D and a generated code amount R is used as the coding efficiency evaluation value. The reference sign λ corresponds to an undetermined multiplier of Lagrange, and is determined according to a quantization parameter.

The coding distortion D is calculated by Sum of Square Differences of an input pixel value si and a local decode pixel value li in each pixel i in a macro block with the expression shown below.

D=Σ|si−li|²

The generated code amount R is calculated from the number of bits after having performed the variable length coding (CABAC or CAVLC).

### (10) Second Method of Determining Coding Efficiency Evaluation Value

An evaluation value J1=D+λ·R_{PRED} using the coding distortion D and the generated code amount estimation value R_{PRED} may also be used as the coding efficiency evaluation value.

The generated code amount estimation value R_{PRED} is calculated from Expression 1 to Expression 9 using transform coefficients after quantization Q, prediction mode information prev_intra4×4_pred_mode_flag, and prev_intra8×8_pred_mode_flag, differential motion vectors information mvd_10 and mvd_11, and reference frame indices ref_idx_10, ref_idx_11.

R_{PRED}=_{αCOEFF}·R_{COEFF}+_{αMODE}·R_{MODE}+_{αMVD}+R_{MVD}+_{αREF}·R_{REF}+β (1)

R_{COEFF}=Σ_{|Q|>0}(1+i log 2(1+|Q|)) (2)

### (Intra4×4 prediction)

R_{MODE}=Σ(4−3·prev_intra4×4_pred_mode_flag) (3)

### (Intra8×8 prediction)

R_{MODE}=Σ(4−3·prev_intra8×8_pred_mode_flag) (4)

### (Other Cases)

R_{MODE}=0 (5)

### (Inter Prediction)

R_{MVD}=Σ_{i=0,1}(1+i log 2(1+|mvd_{—}10[i]|))+Σ_{i=0,1}(1+i log 2(1+|mvd_{—}11[i]|)) (6)

### (Other Cases)

R_{MVD}=0 (7)

### (Inter Prediction)

R_{REF}=Σ(1+ref_idx_{—}10)+Σ(1+ref_idx_{—}11) (8)

### (Other Cases)

R_{REF}=0 (9)

where i log 2(x) is function that returns the position of “1” at the highest level of x, and _{αCOEFF}, _{αMODE}, _{αMVD}, _{αREF}, and β are constant values. However, it is also possible to use different _{αCOEFF}, _{αMODE}, _{αMVD}, _{αREF}, and β for the respective prediction mode or to renew _{αCOEFF}, _{αMODE}, _{αMVD}, _{αREF}, and β during coding according to the characteristics of the input image in order to improve accuracy of the generated code amount estimation.

The calculation expression of R_{PRED} is composed of simple computation such as addition and subtraction, multiplication of constant values, absolute values, and i log 2 as shown from Expressions 1 to 9, and may also be mounted with a small-scale hardware. Since the process of variable length coding which needs frequent memory accessing or branching process and hence needs calculating time may be omitted in comparison with the case of calculating the generated code amount R, the throughput is significantly reduced.

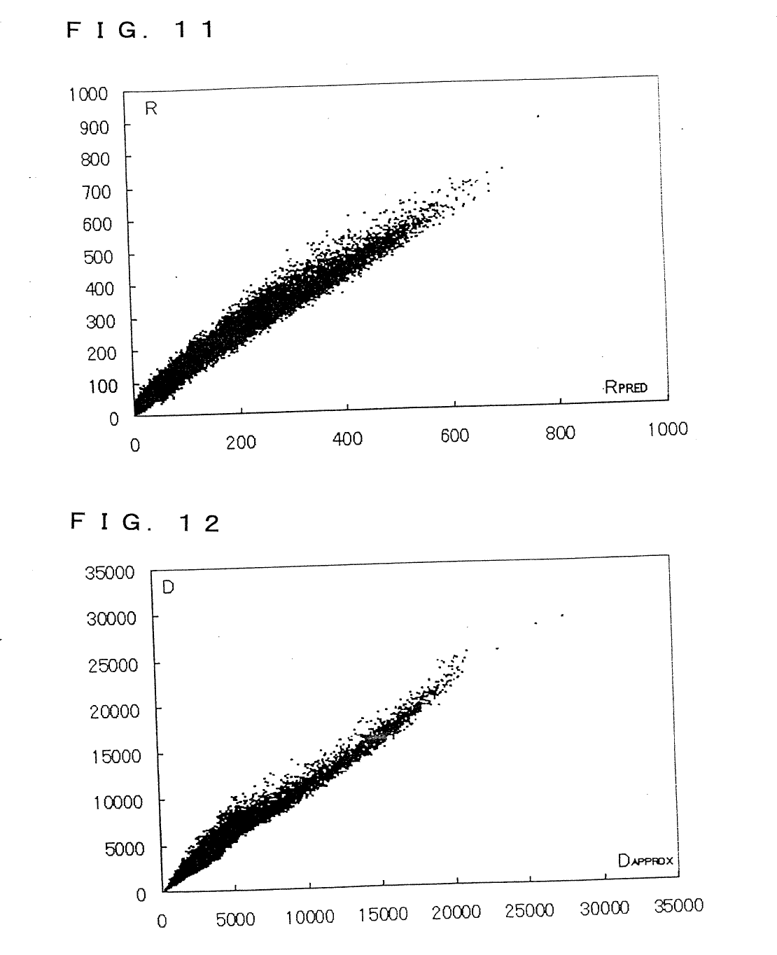

FIG. 11 is a point diagram showing the correlation between R_{PRED} and R, where _{αCOEFF}=2, _{αMODE}=1, _{αMVD}=1.75, _{αREF}=1, and β=2 in the case of IntraChroma prediction, and β=0 in other cases.

In this manner, even when the values which can be multiplied easily are used as _{αCOEFF}, _{αMODE}, _{αMVD} and _{αREF}, the generated code amount estimation value having a high correlation with the actual generated code amount may be calculated.

Since R_{PRED} has a high correlation with R, the mode determination performance of the coding efficiency evaluation value is rarely lowered by using R_{PRED} instead of R.

### (11) Third Method of Determining Coding Efficiency Evaluation Value

It is also possible to use the evaluation value J2=D_{APPROX}+λ·R_{PRED} using the coding distortion approximate value D_{APPROX} and the generated code amount estimation value R_{PRED} as the coding efficiency evaluation value.

The coding distortion approximate value D_{APPROX} is an approximate value of the coding distortion D, and is calculated on the basis of the sum of absolute values D_{SAD}=Σ|si−li| of the input pixel value si and the local decode pixel value li in each pixel i in the macro block.

For example, the coding distortion approximate value D_{APPROX} is calculated as D_{APPROX}=a·D_{SAD} using a constant “a” through linear approximation.

For example, the decoding distortion approximate value D_{APPROX} is calculated as D_{APPROX}=b·D_{SAD}² using a constant “b” through secondary approximation.

For example, the decoding distortion approximate value D_{APPROX}=Yₖ+Rₖ·(D_{SAD}−Xₖ) is calculated through segment line approximation, where (Xₖ, Yₖ) is a coordinate of an k^{th} apex of the segment line, Rₖ is an inclination of the segment connecting the apex (Xₖ, Yₖ) and an apex (Xₖ₊₁, Yₖ₊₁). The value of k is determined to satisfy the relation Xₖ≦D_{SAD}<Xₖ₊₁. At this time, by setting (Xᵢ, Yᵢ) and Rᵢ as Expression 10 to Expression 15, the value of k is introduced by Expression 16, and D_{APPROX} is calculated by the combination of simple computations such as addition and subtraction, shifting, and i log 2 for the calculated value of D_{SAD}. On the other hand, as in FIG. 12, D_{APPROX} has a high correlation with D.

(when i<7)

Rᵢ=1 (10)

(when 7≦i≦12)

Rᵢ=2ⁱ⁻⁶ (11)

(when i>12)

Rᵢ=2⁶ (12)

Xᵢ=2ⁱ−1 (13)

Y₀=0 (14)

Yᵢ₊₁=Yᵢ+Rᵢ·(Xᵢ₊₁−Xᵢ) (15)

k=i log 2(1+D_{SAD}) (16)

As described above, by using D_{APPROX} instead of D, the number of times of multiplication is reduced significantly, and hence the required throughput may be reduced significantly in a platform in which the computation cost of multiplication is high. On the other hand, the mode determination performance is hardly lowered as long as D_{APPROX} and D have a high correlation.

### (12) Fourth Method of Determining Coding Efficiency Evaluation Value

It is also possible to use the evaluation value S=SATD+λ·OH+κ using a SATD (Sum of Absolute Transform Differences) of the prediction residual signal and an overhead OH as the coding efficiency evaluation value. The value “κ” is an offset of the evaluation value, and is determined according to the quantization parameter and the coding mode.

The SATD of the prediction residual signal is calculated by applying Hadamard transformation to the prediction residual signal and calculating a sum of absolute value in the frequency area. The DCT may also be used as the orthogonal transformation instead of Hadamard transformation.

When the coding efficiency evaluation value S is used, the mode determination performance is slightly lowered in comparison with the case in which the coding efficiency evaluation value J is used, but it has an advantage that the throughput required for calculation is low.

### (13) Modification of a Method of Determining Coding Efficiency Evaluation Value

The coding efficiency evaluation value may be the same in all the processes of InterCost Calculation step, IntraLumaCost calculation step, IntraChromaCost calculation step, and the respective mode determination steps, or may be different in the respective processes.

### (13-1) Modification 1

For example, through a high-performance mode determination by using the coding efficiency evaluation value J in all the processes, the coding efficiency is improved.

### (13-2) Modification 2

When the coding velocity is considered to be more important than the coding efficiency, a high-velocity mode determination is performed by reducing the throughput significantly by using the coding efficiency evaluation value S in all the processes.

### (13-3) Modification 3

In the respective mode determination steps, by selecting some prediction methods with the small evaluation value using the coding efficiency evaluation value S, then calculating the coding efficiency evaluation value J only for the selected prediction methods, and setting the prediction method with the smallest evaluation value, the throughput is reduced without lowering the coding efficiency so much.

### (13-4) Modification 4

By using the coding efficiency evaluation value J for the luminance signal and the coding efficiency evaluation value S for the color difference signal, the throughput is reduced without lowering the coding efficiency so much.

It is because that the coding efficiency evaluation value for the color difference signal is smaller than the coding efficiency evaluation value for the luminance signal in many cases since the color difference signal has a smaller number of pixels in the macro block than the luminance signal, and the influence of the selection of the prediction mode of the color difference signal on the coding efficiency is relatively small.

However, since the coding efficiency evaluation value used for the luminance signal is different from that for the color difference signal, one of those needs to be multiplied by a scaling coefficient when these are combined. The value of the scaling coefficient is calculated by obtaining the correlation between the coding efficiency evaluation value J and the coding efficiency evaluation value S in advance.

### (13-5) Modification 5

The throughput is reduced with little lowering of the mode determination performance by using the coding efficiency evaluation value S in Intra4×4 mode determination step, Intra8×8 mode determination step, Intra16×16 mode determination step, and IntraChroma mode determination step and using the coding efficiency evaluation value J in InterLuma mode determination step, Intra mode determination step, InterCost calculation step, IntraLumaCost calculation step, and IntraChromaCost calculation step.

It is because that comparison of the coding efficiency is performed respectively for the prediction methods requiring the same type of information required for generating the prediction signals and having the same prediction block size in Intra4×4 mode determination step, Intra8×8 mode determination step, Intra16×16 mode determination step, and IntraChroma mode determination step, and hence the extent of lowering of the mode determination performance by using the coding efficiency evaluation value S is small.

### (13-6) Modification 6

The throughput is reduced with little lowering of the mode determination performance by using the coding efficiency evaluation value J for the prediction mode having a high likelihood to be selected, and using the coding efficiency evaluation value S for other prediction modes.

For example, considering that the higher coding efficiency is obtained with the inter-frame prediction in the case of P pictures and B pictures in many cases, it is possible to use the coding efficiency evaluation value J in all the processes for I pictures, and use the coding efficiency evaluation value S in Intra4×4 mode determination step, Intra8×8 mode determination step, Intra16×16 mode determination step, and IntraChroma mode determination step, and the coding efficiency evaluation value J in InterLuma mode determination step, Intra mode determination step, InterCost calculation step, IntraLumaCost calculation step, and IntraChromaCost calculation step for P picture and B pictures.

### (13-7) Modification 7

For example, it is also possible to determine the coding efficiency evaluation value to be used in the respective mode determination steps on the basis of the ratio of usage of Intra4×4 prediction, Intra8×8 prediction, Intra16×16 prediction, and Inter prediction in the coded frames. If the Intra4×4 prediction is most used in the coded frames, the coding efficiency evaluation value J is used in Intra4×4 mode determination step and the coding efficiency evaluation value S is used in Intra8×8 mode determination step, Intra16×16 mode determination step, and Inter mode determination step.

### (13-8) Modification 8

For example, it is also possible to determine the coding efficiency evaluation value to be used in Intra4×4 mode determination step, Intra8×8 mode determination step, Intra16×16 mode determination step, and Intra mode determination step on the basis of the value difference between InterCost and IntraChromaCost.

When the value difference between InterCost and IntraChromaCost is small, the probability to determine the usage of the intra-frame prediction is low, and hence the coding efficiency evaluation value S is used in Intra4×4 mode determination step, Intra8×8 mode determination step, Intra16×16 mode determination step, and Intra mode determination step. In contrast, when the value difference between InterCost and IntraChromaCost is large, the probability to determine the usage of the intra-frame prediction is high, and hence the coding efficiency evaluation value J is used in Intra4×4 mode determination step, Intra8×8 mode determination step, Intra16×16 mode determination step, and Intra mode determination.

### (13-9) Modification 9

For example, it is also possible to determine the coding efficiency evaluation value to be used in Intra4×4 mode determination step and Intra8×8 mode determination step according to the size of the input images. When the size of the input image is small, the higher coding efficiency is achieved with Intra4×4 prediction in many cases. Therefore, the coding efficiency evaluation value J is used in Intra4×4 mode determination step and the coding efficiency evaluation value S is used in Intra8×8 mode determination step. In contrast, when the size of the input image is large, the higher coding efficiency is achieved with Intra8×8 prediction in many cases. Therefore, the coding efficiency evaluation value S is used in Intra4×4 mode determination step and the coding efficiency evaluation value J is used in Intra8×8 mode determination step.

### (13-10) Modification 10

It is also possible to reduce the throughput with little lowering of the coding efficiency by using a coding efficiency evaluation value J1 or J2 instead of the coding efficiency evaluation value J in the methods described above.

### Second Embodiment

FIG. 8 is a flowchart of BestIntra4×4 determination in Intra4×4 mode determination step according to a second embodiment of the invention.

In the second embodiment, the process of Intra4×4 mode determination step in the first embodiment is replaced, and other parts of the process are the same as in the first embodiment, and hence are not described here again. Processes which are the same as the processes in Intra4×4 mode determination step in the first embodiment are represented by the same reference numerals in the drawings

Firstly, initialization is performed to satisfy TmpIntraCost=IntraChromaCost (S610).

Then, the prediction signals in the case of employing the respective directions of prediction are generated (S612) for each 4×4 block (S611), the coding efficiency evaluation values are calculated (S613), and the direction of prediction whose evaluation value is the smallest is determined to be an optimal direction of prediction of the target block (S614).

At this time, the coding efficiency evaluation value Intra4×4BlkCost obtained when the target block is coded using the optimal direction of prediction is calculated and the calculated value is added to TmpIntraCost (S615).

TmpIntraCost and InterCost are compared (S616), and when the relation TmpIntraCost>InterCost is satisfied, it is determined not to use Intra4×4 prediction (S616), and the Intra4×4 mode determination process is ended (S617).

On the other hand, when the relation TmpIntraCost>InterCost is not satisfied constantly, the above-described process is performed for the sixteen blocks, and Intra4×4 prediction coding using the obtained sixteen optimal directions is determined as BestIntra4×4.

The reduction of throughput is achieved by ending Intra4×4 mode determination early by the processes in S615 to S617.

The mode determination performance is not lowered as long as the same coding efficiency evaluation value calculating method for calculating Intra4×4BlkCost, Intra4×4Cost, and IntraCost is employed. It is because that InterCost≧IntraCost=IntraLumaCost+IntraChromaCost=Intra4×4Cost+IntraChromaCost=ΣIntra4×4BlkCost+IntraChromaCost is established assuming that it is finally determined to use Intra4×4 prediction, and the relation InterCost<TmpIntraCost is not possible.

The process described thus far may be performed also in Intra8×8 mode determination step.

### Modification

The invention is not limited to the embodiments shown above, and may be modified variously without departing from the scope of the invention.

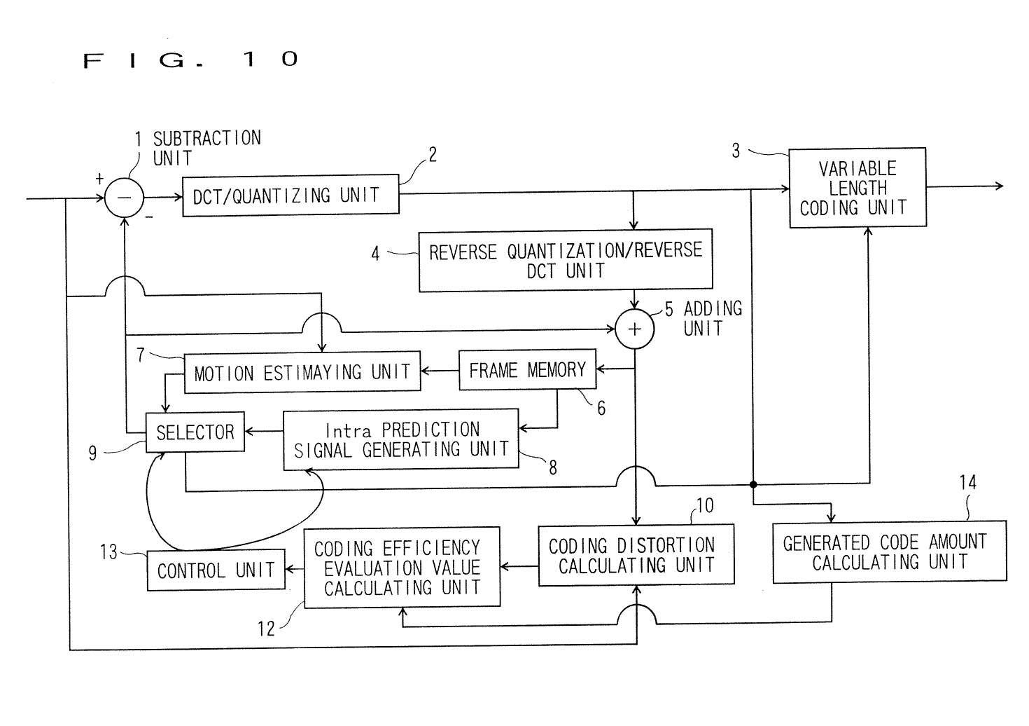

For example, FIG. 10 is a block diagram showing a modification of a configuration of the motion picture coding apparatus.

Since this embodiment is a modification of the motion picture coding apparatus according to the first embodiment, only different parts are described below.

A generated code amount estimating unit 14 estimates a generated code amount from the transform coefficients after quantization outputted from the DCT/quantizing unit 2, the prediction mode information outputted from the selector 9, and the information such as the motion vectors and outputs the same.

The coding efficiency evaluation value calculating unit 12 calculates the coding efficiency evaluation value from the coding distortion outputted from the coding distortion calculating unit 10 and the generated code amount estimation value outputted from the generated code amount estimating unit 14, and outputs the same.

Accordingly, with the configuration of this modification, since the process of the variable length coding does not have to be performed in the provisional coding step, further reduction of the throughput is possible in comparison with the configuration in the first embodiment.

What is claimed is:

1. A motion picture coding apparatus for coding input signals of motion pictures using inter-frame prediction and intra-frame prediction comprising:
a first evaluation value estimating unit configured to estimate a first evaluation value which indicates a coding efficiency based on an inter-frame prediction signal;
a second evaluation value estimating unit configured to estimate a plurality of second evaluation values which indicate coding efficiencies based on intra-frame color difference prediction signals generated according to respective intra-frame color difference prediction modes;
an intra-frame color difference prediction mode selecting unit configured to select a best intra-frame color difference prediction mode having a best second evaluation value based on the second evaluation values;
a first comparing unit configured to compare the first evaluation value and the best second evaluation value and determine a better one in a coding efficiency from the first evaluation value and the best second evaluation value;
a first selecting unit configured to select the inter-frame prediction when the first comparing unit determines the first evaluation value is the better one;
a third evaluation value estimating unit configured to estimate a plurality of third evaluation values which indicate coding efficiencies of intra-frame luminance prediction modes based on intra-frame luminance prediction signals generated according to the respective luminance prediction modes when the first comparing unit determines that the best second evaluation value is the better one;
an intra-frame luminance prediction mode selecting unit configured to select a best intra-frame luminance prediction mode having a best third evaluation based on the plurality of third evaluation values;
a second comparing unit configured to compare the sum of the best second evaluation value and the best third evaluation value with the first evaluation value and determine a better one in a coding efficiency from the sum and the first evaluation value;
a second selecting unit configured to select the inter-frame prediction when the second comparing unit determines that the first evaluation value is the better one;
a third selecting unit configured to select the intra-frame prediction including the best intra-frame color difference prediction mode and the best intra-frame luminance prediction mode when the second comparing unit determines that the sum is the better one; and
a coding unit configured to perform prediction coding through a prediction system selected by any one of the first selecting unit, the second selecting unit, and the third selecting unit.

2. The apparatus according to claim 1, wherein the first evaluation value estimating unit calculates the first evaluation value from a coding distortion and a generated code amount,
wherein the second evaluation value estimating unit calculates the second evaluation value from the coding distortion and the generated code amount, and
wherein the third evaluation value estimating unit calculates the third evaluation value from the coding distortion and the generated code amount.

3. The apparatus according to claim 2, wherein an estimated value is used as the coding distortion.

4. The apparatus according to claim 2, wherein the generated code amount is estimated by using at least one of transform coefficients after quantization of a prediction residual signal of the input signal and the prediction signal, motion vectors of the input signal, and reference frame indices used in the inter-frame prediction.

5. The apparatus according to claim 4, wherein the generated code amount is estimated by the transform coefficients after quantization of the prediction residual signal of the input signal and the predicting signal, the motion vectors of the input signal, the reference frame indices used in the inter-frame prediction, or a polygonal expression of logarithmic values.

6. The apparatus according to claim 1, wherein the first evaluation value estimating unit calculates using a SATD of the prediction residual signal of the input signal and the prediction signal,
wherein the second evaluation value estimating unit calculates using the SATD of the prediction residual signal of the input signal and the prediction signal, and
wherein the third evaluation value estimating unit calculates using the SATD of the prediction residual signal of the input signal and the prediction signal.

7. The apparatus according to claim 6, wherein the first evaluation value is calculated using motion vectors of the input signal and the reference frame indices used in the inter-frame prediction in addition to the SATD.

8. The apparatus according to claim 6, wherein the third evaluation value is calculated using the information relating to the prediction mode in addition to the SATD.

9. A method of coding input signals of a motion picture using an inter-frame prediction and an intra-frame prediction, comprising:
a first evaluation value estimating step of estimating a first evaluation value which indicates a coding efficiency based on an inter-frame prediction signal;
a second evaluation value estimating step of estimating a plurality of second evaluation values which indicate coding efficiencies based on intra-frame color difference prediction signals generated according to respective intra-frame color difference prediction modes;
an intra-frame color difference prediction mode selecting step of selecting a best intra-frame color difference prediction mode having a best second evaluation value based on the second evaluation values;
a first comparing step of comparing the first evaluation value and the best second evaluation value and determining a better one in a coding efficiency from the first evaluation value and the best second evaluation value;
a first selecting step of selecting the inter-frame prediction when the first comparing step determines the first evaluation value is the better one;
a third evaluation value estimating step of estimating a plurality of third evaluation values which indicate coding efficiencies of intra-frame luminance prediction modes based on intra-frame luminance prediction signals generated according to the respective luminance prediction modes when the first comparing step determines that the best second evaluation value is the better one;
an intra-frame luminance prediction mode selecting step of selecting a best intra-frame luminance prediction mode having a best third evaluation based on the plurality of third evaluation values;
a second comparing step of comparing the sum of the best second evaluation value and the best third evaluation value with the first estimation value and determining a better one in a coding efficiency from the sum and the first evaluation value;
a second selecting step of selecting the inter-frame prediction when the second comparing step determines that the first evaluation value is the better one;
a third selecting step of selecting the intra-frame prediction including the best intra-frame color difference prediction mode and the best intra-frame luminance prediction mode when the second comparing step determines that the sum is the better one; and
a coding step of performing prediction coding through a prediction system selected by any one of the first selecting step, the second selecting step, and the third selecting step.

10. The method according to claim 9, wherein the first evaluation value estimating step calculates the first evaluation value from a coding distortion and a generated code amount,
wherein the second evaluation value estimating step calculates the second evaluation value from the coding distortion and the generated code amount, and
wherein the third evaluation value estimating step calculates the third evaluation value from the coding distortion and the generated code amount.

11. The method according to claim 10, wherein an estimated value is used as the coding distortion.

12. The method according to claim 10, wherein the generated code amount is estimated by using at least one of transform coefficients after quantization of a prediction residual signal of the input signal and the prediction signal, motion vectors of the input signal, and reference frame indices used in the inter-frame prediction.

13. The method according to claim 12, wherein the generated code amount is estimated by the transform coefficients after quantization of the prediction residual signal of the input signal and the prediction signal, the motion vectors of the input signal, the reference frame indices used in the inter-frame prediction, or a polygonal expression of logarithmic values.

14. The method according to claim 9, wherein the first evaluation value estimating step calculates using a SATD of the prediction residual signal of the input signal and the prediction signal,
wherein the second evaluation value estimating step calculates using the SATD of the prediction residual signal of the input signal and the prediction signal, and
wherein the third evaluation value estimating step calculates using the SATD of the prediction residual signal of the input signal and the prediction signal.

15. The method according to claim 14, wherein the first evaluation value is calculated using the motion vectors of the input signal and the reference frame indices using the inter-frame prediction in addition to the SATD.

16. The method according to claim 14, wherein the third evaluation value is calculated using the information relating to the prediction mode in addition to the SATD.

17. A motion picture coding program for coding input signals of motion pictures using inter-frame prediction and intra-frame prediction, the program product being stored in a computer readable medium, the program product implementing:
a first evaluation value estimating function for estimating a first evaluation value which indicates a coding efficiency based on an inter-frame prediction signal;
a second evaluation value estimating function for estimating a plurality of second evaluation values which indicate coding efficiencies based on intra-frame color difference prediction signals generated according to respective intra-frame color difference prediction modes
an intra-frame color difference prediction mode selecting function for selecting a best intra-frame color difference prediction mode having a best second evaluation value based on the second evaluation values;
a first comparing function for comparing the first evaluation value and the best second evaluation value and determining a better one in a coding efficiency from the first evaluation value and the best second evaluation value;
a first selecting function for selecting the inter-frame prediction when the first comparing function determines the first evaluation value is the better one;
a third evaluation value estimating function for estimating a plurality of third evaluation values which indicate coding efficiencies of intra-frame luminance prediction modes based on intra-frame luminance prediction signals generated according to the respective luminance prediction modes when the first comparing function determines that the best second evaluation value is the better one;
an inter-frame luminance prediction mode selecting function for selecting a best intra-frame luminace prediction mode having a best third evaluation based on the plurality of third evaluation values;
a second comparing function for comparing the sum of the best second evaluation value and the best third evaluation value with the first evaluation value and determining a better one in a coding efficiency from the sum and the first estimation value;
a second selecting function for selecting the inter-frame prediction when the second comparing function determines that the first evaluation value is the better one;
a third selecting function for selecting the intra-frame prediction including the best intra-frame color difference prediction mode and the best intra-frame luminance prediction mode when the second comparing function determines that the sum is the better one; and
a coding function for performing prediction coding through a prediction system selected by any one of the first selecting function, the second selecting function, and the third selecting function.

18. The program according to claim 17, wherein the first evaluation value estimating function calculates the first evaluation value from a coding distortion and a generated code amount,
wherein the second evaluation value estimating function calculates the second evaluation value from the coding distortion and the generated code amount, and
wherein the third evaluation value estimating function calculates the third evaluation value from the coding distortion and the generated code amount.

19. The program according to claim 18, wherein an estimated value is used as the coding distortion.

20. The program according to claim 18, wherein the generated code amount is estimated by using at least one of transform coefficients after quantization of a prediction residual signal of the input signal and the prediction signal, motion vectors of the input signal, and reference frame indices used in the inter-frame prediction.

21. The program according to claim 20, wherein the generated code amount is estimated by the transform coefficients after quantization of the prediction residual signal of the input signal and the prediction signal, the motion vectors of the input signal, the reference frame indices used in the inter-frame prediction, or a polygonal expression of logarithmic values.

22. The program according to claim 17, wherein the first evaluation value estimating function calculates using a SATD of the prediction residual signal of the input signal and the prediction signal,
wherein the second evaluation value estimating function calculates using the SATD of the prediction residual signal of the input signal and the prediction signal, and
wherein the third evaluation value estimating function calculates using the SATD of the prediction residual signal of the input signal and the prediction signal.

23. The program according to claim 22, wherein the first evaluation value is calculated using the motion vectors of the input signal and the reference frame indices used in the inter-frame prediction in addition to the SATD.

24. The program according to claim 22, wherein the third evaluation value is calculated using the information relating to the prediction mode in addition to the SATD.
